(19) United States
(12) Patent Application Publication
(10) Pub. No.: US 2025/0242475 A1
(43) Pub. Date: Jul. 31, 2025

(54) Pliers

(71) Applicant: Nigel Buchanan, Fife (GB)

(72) Inventor: Nigel Buchanan, Fife (GB)

(21) Appl. No.: 18/854,198

(22) PCT Filed: Apr. 4, 2023
(86) PCT No.: PCT/GB2023/050900

§ 371 Date: Oct. 4, 2024

(30) Foreign Application Priority Data
Apr. 4, 2022 (GB) 2204885.4

(51) Int. Cl. B25B 7/14; B25B 5/06; B25B 5/16; B25B 7/12

(52) U.S. Cl. CPC B25B 7/14; B25B 5/068; B25B 5/166; B25B 7/123

(57) ABSTRACT

Pliers 1 comprising fixed and sliding jaws 207, 300 operated by fixed and moving handles 200, 400 wherein a force triangle 800 is formed with its base 801 between the sliding jaw 300 pivot pin 600 and the pivotal strut 500 pivot pin 601, the triangles apex 802 formed within the pivotal strut outer end pivot bore 504. As the operator clenches CF the moving and fixed handle grips 408, 213 said force triangles apex 802 is propelled towards said triangle base 801, forcefully elongating said base 801, forcing the sliding jaw 300 towards the closed position, the sliding jaw 300 incorporates roller pins 600, 601 ensuring ease of movement upon the fixed head parallel rail 205. The fixed handle 200 incorporates two fold out arms 218, which can form part of a three legged base allowing use as a portable vice. The moving handle 400 can incorporate a further locking rocker switch 700 that can be utilised in both a switchable locking position or non-locking position upon a correspondingly toothed fan 505 within the pivotal strut 500 between said handles 200, 400.

### FIELD OF INVENTION

The invention relates to hand operated gripping tools, gripping tools that are adjustable within the range of the jaws of the tool. One form of hand operated gripping tool is of the locking type generally referred to as “mole grip pliers” or “vice grip pliers” as they are colloquially known.

The invention further relates generally to pliers and also to pliers used to lock their grip upon articles of various sizes and shapes within the confines of the pliers jaw gap sizes, whereas the pliers can be used as a portable vice used to grip and then enable work on fly fishing hooks, jewellery, electronics and model making etc.

### BACKGROUND TO THE INVENTION

Pliers of various types are well known in the art. Pliers in general are used for cutting or gripping, whilst some pliers incorporate locking mechanisms, the generic name being “vice grips”. These pliers are used to clamp parts together whereas usually the pliers attach themselves to the parts that are being clamped. Parts that are clamped are held by the jaws and positioned by the manual gripping of the handles.

Existing Water Pump pliers have the common characteristic of jaws offset at an angle to the Pliers handles and a pivot post, in the form of a bolt or rivet, mounted in the area rearward of the jaw on one of the handles and projecting through an elongate slot on the other handle. In such pliers, means for enabling selective spacing of the distance between the jaws is variously provided by spaced apart ridges or teeth along the inside long edge of the slot adapted for incremental selective binding engagement with the pivot post. Another well-known method of providing distance adjustment between the jaws in such pliers is the provision of spaced apart arcuate ridges on the interfacing surfaces adjacent to the pivot point. All such tools in order to be adjusted to the size of a particular workpiece to be gripped between the jaws, require a two handed operation when the handles are pulled apart to permit a sliding action of the pivot post along the slot to move the jaws to approximately the desired workpiece size.

Existing locking pliers such as US2015283681(A1) Wu, US2015273664(A1) Skodje, Calgar, Cripps comprise of two robust handles connected to two robust jaws, and a locking mechanism connected to the two jaws. The handles can be squeezed to close the jaws. The locking member is attached to an over centre linkage which when utilized prevents the lower handle from pivoting from its closed configuration and until opened retaining the jaws in a closed position. The clamping width of the jaws being adjusted by an adjustment screw, the adjustment screw further determining the clamping pressure exerted upon the clamped workpiece. As the clamping pressure requires to be preordained it can take several attempts to correctly adjust the screw to the required position in order to clamp the workpiece the best way. The clamping width of the jaws once set by the adjusting screw is finite, any movement, vibration or relaxing of the clamped material normally resulting in the failure of the clamping action, this is most prevalent when the device is used to initially clamp bodywork parts during the panel beating process prior to welding or bolting the panels being worked on. Furthermore, inadvertent over pressure applied by the clamping jaws usually results in the damage or distortion of the clamped parts.

USD742194, 2015-11-03 Engel, Albrecht shows a set of pliers having a toothed strut with a locking mechanism attached to one operating arm, as the arms are closed the teeth “ratchet” past the lock, as the operating arms are not designed to resiliently deform during robust operation, the toothed arc of the strut remains in substantially the same locking angle relative to the locking mechanism, however robust pressure would result in problematic locking angles.

EP2818280(A2) 31/12/2014 Buchanan comprises pliers or clamps having a single bow or arcuate portion to permit limited flexing of one of the handles. A pivotal strut retained between the handles, the strut slidably held in a channel within one handle and pivotally held within the other handle. The pivotal end of the strut having a toothed arc which acts with a further switched pawl to lock or unlock the handle positions relative to one another. The compression of the handles closing the gap between the fixed and moveable jaws, the moveable jaw sliding up a clamp bar portion until the jaws robustly contact the workpiece, the further operation of the handles resulting in the clamping of the workpiece, the resilient arcuate portion acting to impose a limited sprung grip upon the workpiece, further usefulness imported by the locking action of the pawl teeth within the strut arc teeth when the pawl is switched into its ratchet locking position retaining the handles substantially in their closed position providing a limited spring grip upon the workpiece. These pliers although efficient are expensive and complex to manufacture, It is a further object of the present invention to at least partially alleviate the above mentioned disadvantages, or to provide an alternative to existing products. In particular producing a more cost-effective product, capable of more than one function.

### SUMMARY OF THE INVENTION

The invention provides pliers wherein the main fixed handle incorporates two fold out arms which when opened out form with the aid of a further protrusion at the opposite jaw end of the fixed handle a very stable three legged base such to allow the fixed handle to be placed on a table or the like with the three base legs or feet protruding downwards such as to form a stable base for the pliers operation, the moveable arm can now be manually operated by one hand usefully leaving the other hand to position the workpiece.

The invention further includes a method whereas when the arms are folded out to form a base and the fixed handle feet are placed on say a bench the jaws are positioned generally upright enabling any work piece held within the jaws to be extremely accessible.

The invention further includes a method whereas the jaws, when the moving handle is operated, close in a substantially parallel manner, providing a superior grip upon most workpieces.

The invention further includes a method whereas the jaws, when the moving handle are operated, close in a substantially parallel manner, thereby when the jaws gripping profiles in best practice include a lateral groove in best practice consisting of a V shaped channel providing a superior grip upon thin generally cylindrical shaped workpieces such as fishing hook shanks. When usefully combined with gripping face teeth that can recess into one another instead of the prior art generally peak to tooth peak grip, the grip of fine rod or wire like structures is greatly improved.

The invention further includes a method whereas the arms when folded out can usefully remain in the folded out position.

The invention further includes a method whereby the arms when folded in can further lock in the folded in position in order to form a rigid uniform handle for normal pliers use.

The invention further includes a method whereby the fold out arms can usefully employ recesses and apertures at their extremities in order to facilitate the fitment of a lanyard or cord so that the pliers employing the lanyard can be now usefully hung from around the user's neck or such, when the pliers arms are folded out. The pliers can be usefully stably positioned on say the chest of the user whereby in one of the pliers many functions it can be utilised to lock in a vice like way upon say, a fishing hook in order to facilitate the tying of various lure type materials such as feathers onto the said hook. The pliers operator, if in a situation such as aboard a small fishing boat has now a far more stable platform in which to perform this function, as opposed to a situation whereby a portable vice attached to the boat is employed. In the present invention the pliers and workpiece goes up and down with the operator whereas the boat attached type vice goes up and down with the boat, which is a problem as and when the boat is subjected to any swell as this creates a situation that negates any precision work being accomplished. A further locking mechanism can be utilized to allow expedient adjustment of the preferred lanyard length.

The invention also includes a method whereas the arms rotationally mounted on the fixed handle by the fold out arms pivot pin have protrusions upon the circumference of their axis pin housings which act as useful stops against the fixed handle such as to locate the arms in their closed position or full open position as required, further protrusions and corresponding locking indentations are utilised upon the mating surfaces of the arms to the fixed handle distil end, the fixed handle fold out arm pivot pin being latterly adjustable requires no further method of preventing slackness in operation.

The invention comprises a fixed handle incorporating a metal fixed internal framework. A fixed head portion incorporating its fixed gripping jaw within the fixed handle proximal end and first and second fold out arms at its distil end. The moving handle further pivotally attached at its moving handle proximal end, to the sliding jaw by the sliding jaw actuation roller pin, characterised wherein a non-adjustable scalene or Isosceles type force triangle is formed with its force triangle base situated at one end between the pivotal strut inner end pivot pin bore and fixed handle to strut pivot pin bore by the fixed handle to strut pivot pin and at its other end the pivotal jaw actuation pin, pivotal within the sliding jaw actuation roller pin bore and moving handle actuation arm pin bore, the force triangles apex being formed within the pivotal strut outer end pivot bore and corresponding moving handle central pivot pin bore by the incumbent force triangle apex pivot pin. The force triangle first side formed between the moving handle central apex pivot pin and the sliding jaw actuation roller pin, the force triangle second side formed within the span of the pivotal strut between its fixed handle to strut pivot pin bore and its moving handle central apex pivot pin bore. During use as the operator provides clenching force forcing the moving handle towards the fixed handle, the force triangles apex, the moving handle central apex pivot pin, is propelled towards the force triangle base, forcefully elongating said force triangle base line, all the said triangle pivot pin points rotationally fixed within their allotted pivot bores, said pivot pins being pivotal in the same plane. The moving handle central strut pivot pin bore is positioned as near as practical to the moving handle proximal end within the moving handle grip such that as clenching force is applied between the fixed and moving handle grips, the greater part of the finger clenching force applied rotates the moving handle grip distil end inwards around the generally central moving handle triangle apex pivot pin, towards the fixed handle distil end, further rotating the moving handle grip distil end around the generally central moving handle triangle apex pivot pin. Further rotating the moving handle actuation arm pivotally connected to the sliding jaw actuation pivot bore and pin, further forcefully propelling the sliding jaw gripping profile towards the closed position against the fixed jaw gripping profile, the elongation closure forces employed provide an expedient and smooth closure function that can be because of the now greatly reduced distance between the said fixed and moving handles grips can easily be operated by one hand or smaller hands.

The invention also includes a method whereas the sliding jaw, when the moving handle is operated, closes in a substantially parallel manner upon the fixed gripping jaw, providing a superior grip upon most workpieces. The sliding jaw traverses as required along the fixed head parallel rail roller surfaces, this embodiment is characterized by comprising in best practice a minimum of three roller pins, situated within the sliding jaw parallel rail recess, the sliding jaw actuation roller pin and two further stabilizing roller pins within corresponding sliding jaw axle bores, enable said sliding jaw, to glide along the fixed head parallel rail roller surfaces, with a minimum of friction when it is propelled towards the closed position or retracted by the moving handle main spring in the release or opening sequence. Said roller pins are rotationally held within the sliding jaw parallel rail recess whereas said roller pins can rotate within their allotted sliding jaw actuation or stabilizing roller pin bores within said sliding jaw parallel rail recess, the correct orientation of said roller pins within said sliding jaw parallel rail recess gives a triangulated, secure method of the sliding jaw traversing the allotted length of the fixed head parallel rail whilst ensuring the sliding jaw gripping profile remains generally parallel to the fixed jaw gripping profile. The tolerances between the roller pins within said sliding jaw parallel rail recess and the corresponding fixed head parallel rail roller surfaces ensuring that the sliding jaw remains at the preordained set angle to that of the fixed jaw which is further robustly affixed to the fixed head parallel rail by its correspondingly sized fixed jaw parallel rail recess and associated fixing holes.

The invention also includes a method whereas the moving arm incorporates a bowed flexible portion in order to provide the jaws with a resilient closing pressure, the locking arm pivot joint is positioned further out-with the bowed flexible portion in relation to the jaws, the action of the toothed pivotal strut and moving handle pivotal switch locking mechanism provides an operator an adjustable level of locking, resilient, jaw gripping pressure, the actuation arm bowed flexible portion usefully providing an extremely robust resilient jaw closing action whilst incurring no extra parts or cost, this resilient jaw closure provides superior gripping of less robust items compared to the pliers of the known art as the prior art pliers tend to crush the workpiece in order to provide sufficient gripping action, a further utilisation of the resilient jaw closing action is if the workpiece size alters for whatever reason after the gripping action has been completed the resilient action of the resilient bowed section of the moving handle would usefully compensate.

The resulting pliers can have reasonably soft gripping pressures for gripping soft materials like lead soldiers or electronic chips or the like in the first instance and when further stronger sprung, moving handle actuation arm laminates are employed, hardened steel hooks or any other object requiring a robust grip can be capably worked on. When the required gripping pressure is attained and the handle clenching grip pressure is relaxed, the actuation arm resiliently bowed portion moves towards its initial pre-stressed position whereby the rocker switch toothed arc teeth can robustly engage with the pivotal strut toothed fan teeth aided by the corresponding rocker switch closure spring. This action expediently engages the locking interaction between the strut teeth and the switch teeth.

The invention fixed and moving handle grips are specifically ergonomically shaped to provide one handed ease of use by smaller hands, characterized wherein the fixed handle grip has a concave shape portion for contact with the operators web between the thumb and forefinger, the moving handle grip having further finger grip profiles formed according to normal corresponding finger lengths from the fixed handle grip, giving superior enablement of use by smaller hands.

The invention can further incorporate clamping widths within its specification that are automatically adjusted, the locking pressure can be further be usefully determined by the operator by the straightforward gripping pressure of the handles, the simple release of the handles initiating the locking of the jaws upon the clamped parts.

The invention further works on a reasonable range of workpiece sizes and shapes whilst utilizing superior sprung gripping force of the workpiece. Furthermore, the main framework parts are capable of being stamped in order to further reduce their environmental impact whilst reducing their manufacturing cost.

The invention further includes a method whereas the clamping action of the jaws, are determined by the resilience of the actuation arm resiliently bowed portion, the elastic potential energy.

The invention also includes a method whereby part of the locking mechanism includes a pivotal strut pivotally attached to the fixed handle by the fixed handle to strut pivot pin, when the moving handle is closed towards the fixed handle as in the clamping process, the pivotal strut toothed fan teeth ratchet against the appropriate opposing rocker switch toothed arc teeth with a commercially prudent satisfying sound. As the handle closing pressure is released the opposing teeth profiles mesh into a locking position further propelled by the rocker switch closure spring utilised. Thereby usefully locking the fixed and sliding jaws closed upon the workpiece, preferably single direction “shark teeth” type sets of opposing locking teeth being further chosen to prevent inadvertent disengagement during pliers use.

The invention also includes a safety method whereby the operator requires to first disengage the opposing locking teeth from their engaged position by applying closure pressure to the pliers handles in order to reduce the force required to operate the rocker switch trigger profile, the simultaneous operation of the rocker switch allows the jaws to smoothly open under the resilient tension of the moving handle main spring.

The invention further includes a method whereas the pivotal strut which comprises the force triangles first side situated between the fixed handle to strut pivot pin and the moving handle to central apex pivot pin incorporates within the pivotal strut outer end a toothed fan utilizing single direction saw shaped toothed fan teeth, further characterized by the use of, in best commercial practice, a trigger finger operated, rocker switch situated within the moving handle finger grip profiles, said rocker switch having generally central pivotal axles allowing said rocker switch to pivot around corresponding rocker switch axle pivot bores within the moving handle metal internal framework, a rocker switch closure spring is further utilized to urge the rocker switch trigger profile outwards in order to propel its opposite toothed arc resiliently into mesh with the correspondingly toothed and profiled, pivotal strut outer end toothed fan. In order to construct a low cost heavy duty, ratcheting locking mechanism, the pivotal strut toothed fan teeth utilized further comprising a safety lock as the fixed and moving handles require to be clenched at the same clenching force used in the workpiece gripping sequence before and as the said finger operated rocker switch trigger profile is operated, thereby smoothly and safely unlocking the said pliers, further characterized in a reduction of parts and costs by the direct inclusion of the trigger profile and toothed arc teeth within the rocker switch.

The invention further includes a method whereas if the finger operated rocker switch trigger profile is compressed whilst the fixed and moving handles are clenched the said pliers can be further conveniently utilized as non-locking pliers.

The invention is further specifically designed, wherein in order to further reduce the manufacturing environmental impact to a minimum, the fixed and moving handles internal frameworks are preferably made from stamped planar metal plate with their as required laminated layers riveted or pinned together, the fixed and moving handle grips in best practice being made from recycled plastic, said handle grips characterized by the fixed and moving handles internal framework/laminates engaging into slots within the fixed and moving handle grips the fixed handle dowel holes held by assembly dowels. The moving handle grip, further engaged by the moving handle internal framework by its internal spacers and affixed by assembly dowels within said moving handle grip dowel holes transforming the thin, sideways pliable metal moving handle internal framework into an extremely ruggedized moving handle whilst using the very minimum or absence of assembly rivets. The assembly of the fixed and moving handle grips is characterized by the use of appropriate lengths of in best practice tube like hollow dowels which when installed are suitably retained by the interaction by the edges of fixed and moving handle dowel holes of the fixed and moving handle internal framework, although solid assembly dowels could be used the hollow dowels slightly resilient walls, cost and weight reductions are preferable.

This type of extremely cost effective and expedient (under 10 seconds) final assembly allowing several differing badged, cosmetic or colour, fixed and moving handle grip types as required to be fitted to a uniformly standard fixed or moving handle internal framework prior to despatch.

The invention also includes a method whereas the jaws are preferably replaceable with other jaw type configurations in order that the pliers can be utilised in many differing marketplaces such as fishing, electronics, electrical to mention but a few. The methods of attachment of the fixed and moving jaws, being of known screws or the like.

The invention also includes a method whereas the complex shaped jaws can be preferably injection moulded utilising a method termed Metal Injection Moulding or MIM, as this is a costly process yet extremely accurate, the size of the moulded parts should be kept to a minimum in order to achieve maximum cost savings, to this end only the complex parts of the pliers are moulded the less expensive stamped handle frames etc. being attached to the fixed jaw by known methods.

The invention also includes a method wherein the design is utilized without the fixed handle first or second fold out arms for further use as parallel closing, locking or non locking, pliers, water pump pliers or clamps (not shown). Comprising a fixed handle fixed head parallel rail, roller surfaces and corresponding sliding jaw actuation and stabilizing roller pins for the ease of closure of the sliding jaw towards the fixed jaw when the moving handle is operated towards the fixed handle, the optional rocker switch can also be further incorporated.

The invention also includes pliers comprising:
a fixed jaw and a moving jaw that is movable towards and away from said fixed jaw to vary the size of a gap therebetween;
a fixed handle comprising a hand grip portion and a guide rail for the moving jaw, said fixed jaw being fixed to said fixed handle such that said guide rail is disposed between said fixed jaw and said hand grip portion; and
a moving jaw handle connected with said moving jaw for moving the moving jaw along said guide rail towards said fixed jaw,
wherein said guide rail disposes a first guide surface and a second guide surface disposed opposite and spaced from said first guide surface and said moving jaw is provided with a first roller pin engaged with said first guide surface and a second and third guide roller pin each engaged with said second guide surface.

While one or more preferred embodiments of the invention have been described above, it should have been understood that any and all equivalent realisations of the invention are included within the scope and spirit thereof. The embodiments depicted are presented by way of example only and are not intended as limitations upon the invention. Thus, it should be understood by those of ordinary skill in this art that the invention is not limited to these embodiments since modifications can be made. Therefore, it is contemplated that any and all such embodiments are included in the invention as may fall within the scope of appended claims.

### BRIEF DESCRIPTION OF THE DRAWINGS

In order that the invention may be well understood, some examples thereof, which are given by way of example only, will now be described with reference to the drawings in which:

FIG. 1 is a perspective view of the pliers from the front, the pliers are in the open position, the fold out legs are also in the open position.

FIG. 2 is a perspective view of the pliers from the rear, the legs of the fixed handle are illustrated closed and the jaws open.

FIG. 3 is a perspective view of the pliers from the front, the legs of the fixed handle are illustrated open with a lanyard attached, the pliers are operated and the jaws gripping as an example a fishing hook.

FIG. 4 is a side plan view of the inner metal frame and jaws of the pliers, for display purposes the handle grips are shown in section, the pliers are at rest.

FIG. 5 is a side plan view of the inner metal frame and jaws of the pliers, for display purposes the handle grips are shown in section, the pliers are shown operated gripping a workpiece.

FIG. 6 is a rear plan view the legs of the fixed handle are illustrated open.

FIG. 7 is a rear plan view the legs of the fixed handle are illustrated closed.

FIG. 8 is a side plan view of the inner metal frame and jaws of the pliers, for display purposes the handle grips are shown in section, the pliers are at rest.

FIG. 9 is a side plan view of the inner metal frame and jaws of the pliers, for display purposes the handle grips are shown in section, the pliers are shown operated gripping a workpiece.

FIG. 10 is a close up perspective view of the fixed and sliding jaws and associated roller pins.

FIG. 11 the pliers are shown operated gripping a workpiece the handles being clenched and the rocker switch trigger profile being operated in order to release the gripping action.

FIG. 12 is a perspective view of the pliers, the main parts shown dismantled for display purposes.

FIG. 13 is a perspective view of the pliers, utilized without the fixed handle first or second fold out arms, for use as locking or non locking, pliers, water pump pliers or clamps.

FIG. 14 is a close-up view of the pliers parallel sliding jaw roller mechanism.

### REFERENCE TO THE DRAWINGS

Following is a listing of the various components used in the best mode preferred embodiment and alternative embodiments. For the ready reference of the reader the reference numerals have been arranged in ascending numerical order.

| | |
|---|---|
| 10 | Pliers |
| 11 | Pliers Front Aspect |
| 12 | Pliers Rear Aspect |
| 13 | Pliers Upright Aspect |
| 200 | Fixed Handle |
| 201 | Fixed Internal Framework |
| 202 | Fixed Handle Distil End |
| 203 | Fixed Handle Proximal End |
| 204 | Fixed Head Portion |
| 205 | Fixed Head Parallel Rail |
| 206 | Fixed Jaw Parallel Rail Roller Surfaces |
| 207 | Fixed Gripping Jaw |
| 208 | Fixed Jaw Gripping Profile |
| 209 | Fixed Jaw Teeth |
| 210 | Fixed Handle To Fixed Head Pin Holes |
| 211 | Fixed Handle To Strut Pivot Pin Bore |
| 212 | Fixed Handle Dowel Holes |
| 213 | Fixed Handle Grip |
| 214 | Fixed Handle Grip Retaining Slot |
| 215 | Fixed Handle Grip Dowel Holes |
| 216 | Fixed Handle Grip Concave Portion |
| 217 | Fold Out Arms Lanyard Holes |
| 218 | Fixed Handle First Fold Out Arm |
| 219 | Fixed Handle Second Fold Out Arm |
| 220 | Fixed Handle Fold Out Arm Base Feet |
| 221 | Fixed Handle Fold Out Arm Tip Base Feet |
| 222 | Fixed Handle Grip Base Feet |
| 223 | Fold Out Arm Locking Out and In Protrusions |
| 224 | Fold Out Arm Locking In and Out Indentations |
| 225 | Fixed Jaw Parallel Rail Recess |
| 300 | Sliding Jaw |
| 301 | Sliding Jaw Gripping Portion |
| 302 | Sliding Jaw Gripping Profile |
| 303 | Sliding Jaw Gripping Teeth |
| 304 | Sliding Jaw Actuation Roller Pin Bore |
| 305 | Sliding Jaw Stabilizing Pin Bores |
| 306 | Sliding Jaw Parallel Rail Recess |
| 307 | Sliding Jaw Rear Aspect |
| 308 | Sliding Jaw Outer Gripping Point |
| 400 | Moving Handle |
| 401 | Moving Handle Proximal End |
| 402 | Moving Handle Central Pivot Bore |
| 403 | Moving Handle Actuation Arm |
| 404 | Moving Handle Actuation Arm Pin Bore |
| 405 | Moving Handle Distil End |
| 406 | Actuation Arm Resilient Bowed Portion |
| 407 | Moving Handle Main Spring |
| 408 | Moving Handle Grip |
| 409 | Moving Handle Grip Finger Profiles |
| 410 | Moving Handle Grip Spacers |
| 411 | Moving Handle Grip Dowel Holes |
| 412 | Moving Handle Main Spring Pin Holes |
| 413 | Moving Handle Rocker Switch Axle Bores |
| 414 | Moving Handle Metal Laminates |
| 415 | Moving Handle Internal Framework |
| 416 | Moving Handle Grip Slots |
| 417 | Moving Handle Grip Fourth Base Foot |
| 418 | Moving Handle Framework Dowel Holes |
| 500 | Pivotal Strut |
| 501 | Pivotal Strut Inner End |
| 502 | Pivotal Strut Inner End Pivot Pin Bore |
| 503 | Pivotal Strut Outer End |
| 504 | Pivotal Strut Outer End Pivot Pin Bore |
| 505 | Pivotal Strut Outer End Toothed Fan |
| 506 | Pivotal Strut Toothed Fan Teeth |
| 507 | Pivotal Strut Fan Spring Hole |
| 508 | Pivotal Strut Laminates |
| 600 | Sliding Jaw Actuation Roller Pin |
| 601 | Sliding Jaw Stabilizing Roller Pin |
| 602 | Fixed Handle To Strut Pivot Pin |
| 603 | Moving Handle Central Apex Pivot Pin |
| 604 | Main Spring Retaining Pin |
| 605 | Assembly Dowels |
| 606 | Rivet Holes |
| 607 | Assembly Rivets |
| 608 | Fold Out Arms Pivot Pin |
| 700 | Rocker Switch |
| 701 | Rocker Switch Closure Spring |
| 702 | Rocker Switch Trigger Profile |
| 703 | Rocker Switch Toothed Arc |
| 704 | Rocker Switch Toothed Arc Teeth |
| 705 | Rocker Switch Axles |
| 800 | Force Triangle |
| 801 | Force Triangle Base |
| 802 | Force Triangle Apex |
| 803 | Force Triangle First Side |
| 804 | Force Triangle Second Side |
| CF | Clenching Force |
| GF | Gripping Force |
| W | Workpiece |
| S | Surface |
| L | Lanyard |

### Detailed Description of the Illustrated Embodiments

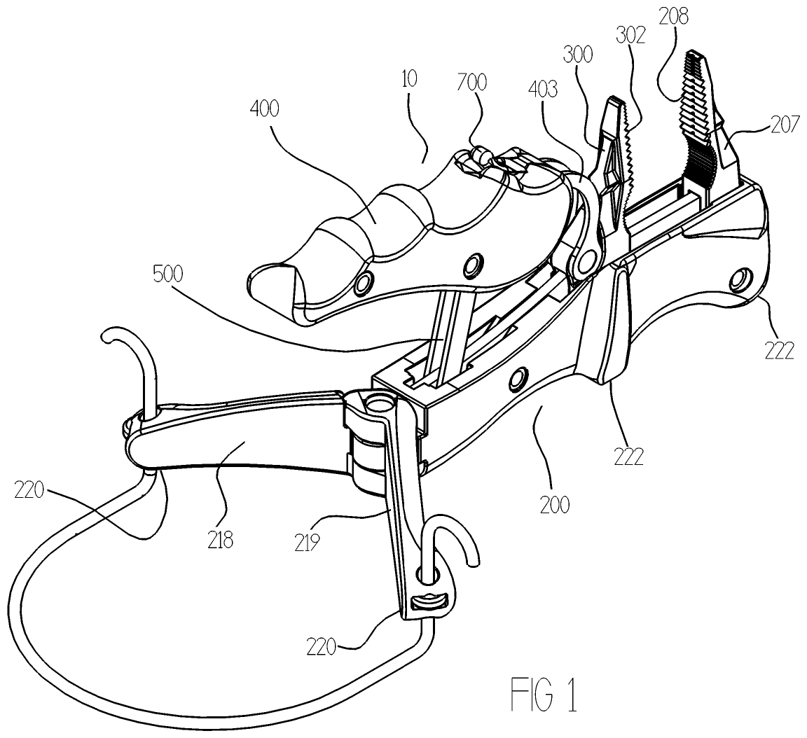

Referring to FIG. 1, the pliers 10 comprise of fixed and sliding jaws 207, 300 with gripping profiles 208, 302 a fixed handle 200, moving handle 400 actuation arm 403 resilient bowed portion 406 and rocker switch 700. The pivotal strut 500 is situated between the fixed and moving handles 200, 400 which are further shown utilizing grips 213, 408. The fixed handle 200 first and second fold out arms 218, 219 are illustrated in the open position. The said Pliers 10 fixed handle 200 first and second fold out arms 218, 219 base feet 220 and the fixed handle grip base feet 222.

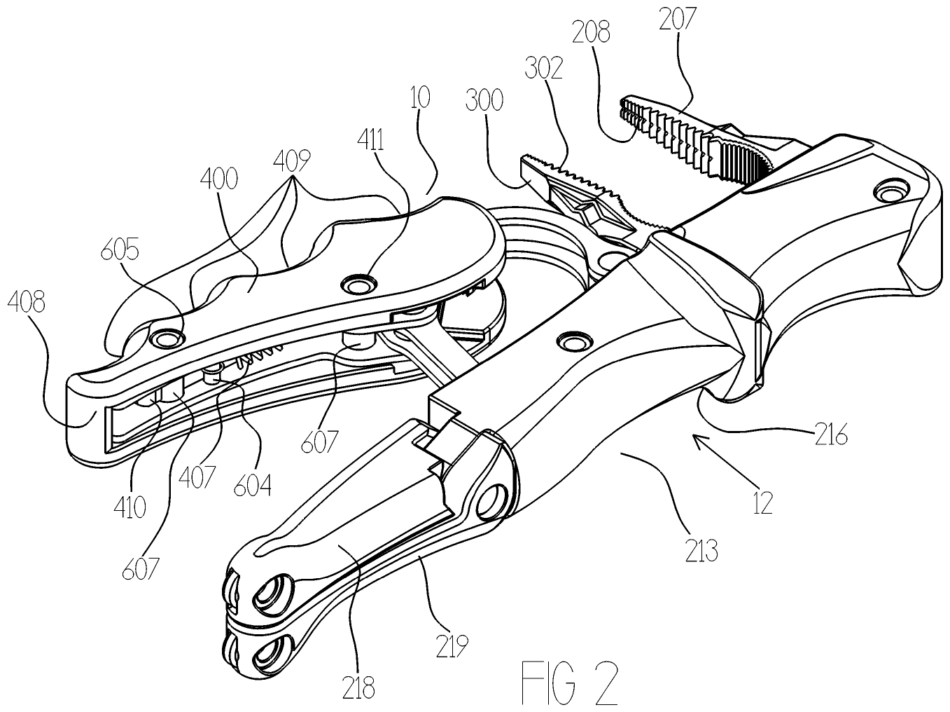

Referring to FIG. 2 the Pliers 10 comprise of fixed and sliding jaws 207, 300 with gripping profiles 208, 302 a fixed handle 200, moving handle 400 actuation arm 403 resilient bowed portion 406. Said Pliers 10 are viewed from their rear aspect 12, whereas the first and second fold out arms 218, 219 are shown in the closed position, further illustrating the fixed handle grip 213 concave portion 216 and moving handle grip 408 finger profiles 409. The moving handle main spring 407 and its retaining pin 604, the moving handle 400 grip 408 dowel holes 411 with incumbent assembly dowels 605, the moving handle internal framework 415 with associated moving handle grip spacers 410, also the rocker switch 700 toothed arc 703 teeth 704 are further shown. The fixed and moving handle grips 213, 408 are specifically ergonomically shaped to provide one handed ease of use by smaller hands, characterized wherein the fixed handle grip 213 has a concave portion 216 for contact with the operators web between the thumb and forefinger, the moving handle grip 408 having further finger grip profiles 409 formed according to normal corresponding finger lengths from the fixed handle grip 213 giving superior enablement of use by smaller hands.

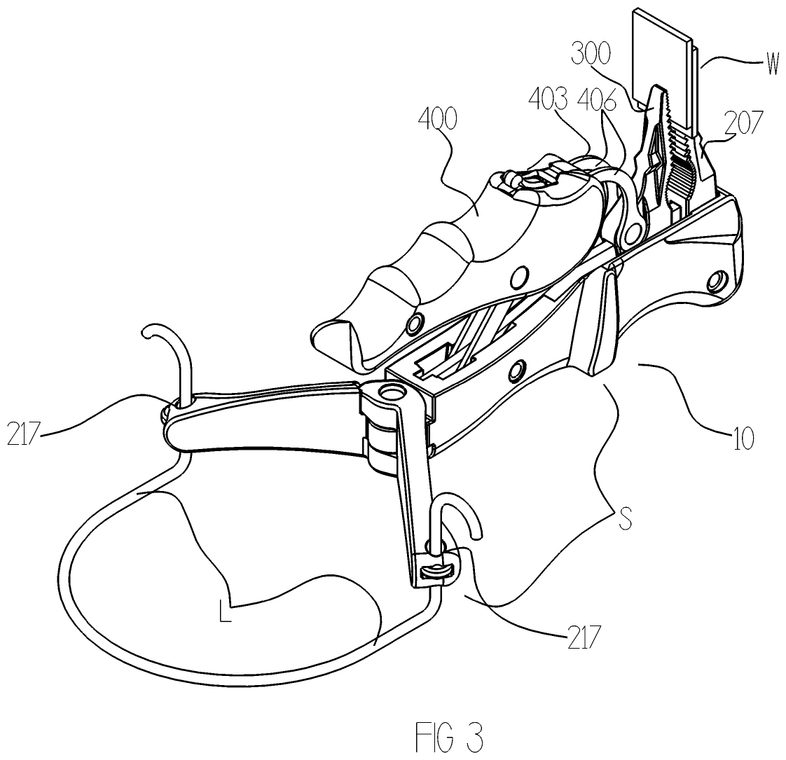

Referring to FIG. 3 the Pliers 10 are illustrated closed, resting on a surface S, gripping a workpiece W, in this example a fishing hook between the fixed and sliding jaw 207, 300 gripping profiles 208, 302. The moving handle 400 actuation arm 403 resilient bowed portion 406, when the resilience level is correctly chosen, providing elastic potential energy as a method of ensuring a continued adequate grip of the workpiece W with far less chance of crushing or even marking the surface of the gripped or clamped workpiece W. Also displayed is a lanyard L held through the fold out arm lanyard holes 217.

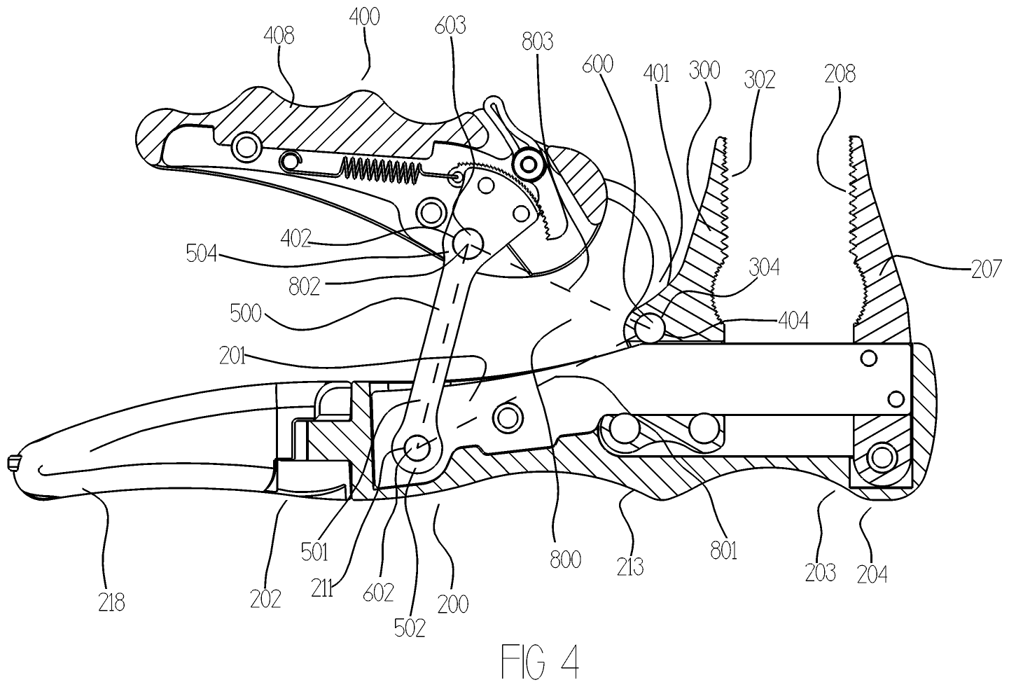

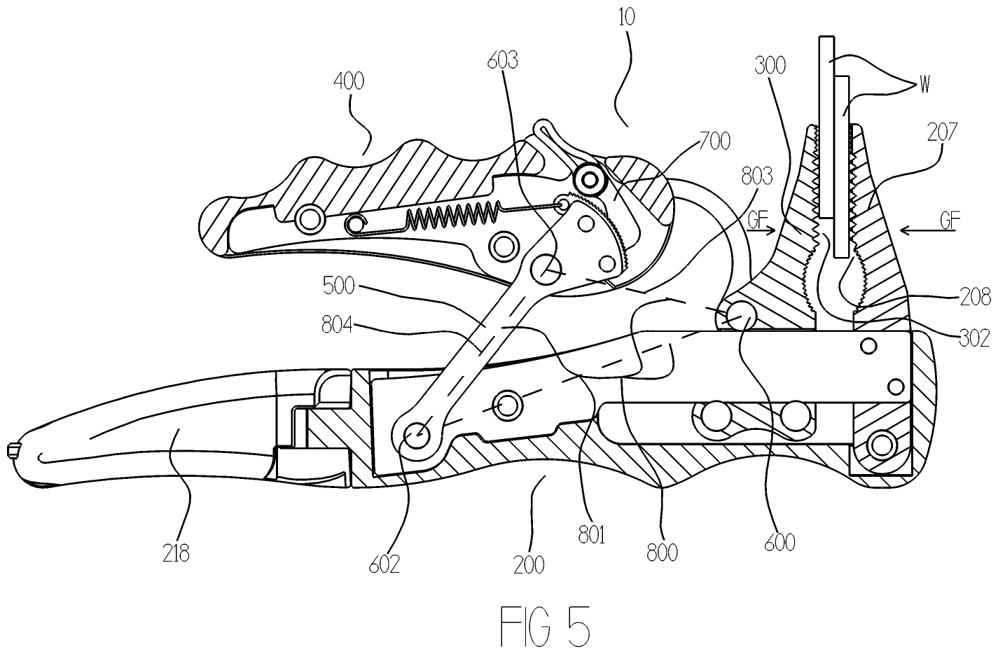

Referring to FIGS. 4 and 5 the Pliers 10 are shown in the open position the moving and fixed handle 400, 200 grips 408, 213 shown in section, illustrating the fixed and sliding jaw 207, 300 closure sequence employed. Comprising a fixed handle 200 incorporating a metal fixed internal framework 201, a fixed head portion 204 incorporating its fixed jaw 207 within the fixed handle proximal end 203 and first fold out arm 218 at its distil end 202, the moving handle 400 further pivotally attached at its moving handle proximal end 401, to the sliding jaw 300 by the sliding jaw actuation roller pin 600, The first embodiment characterised wherein a non-adjustable scalene or Isosceles type force triangle 800 is formed with its force triangle base 801 situated at one end between the pivotal strut 500 inner end 501 pivot pin bore 502 and fixed handle to strut pivot pin bore 211 by the fixed handle to strut pivot pin 602 and at its other end the sliding jaw actuation pin 600 pivotal within the sliding jaw actuation roller pin bore 304 and moving handle actuation arm pin bore 404, the force triangle apex 802 being formed within the pivotal strut outer end pivot pin bore 504 and corresponding moving handle central pivot pin bore 402 and further incumbent moving handle central apex pivot pin 603, the force triangle first side 803 formed between the moving handle 400 central apex pivot pin 603 and the sliding jaw actuation roller pin 600, the force triangle second pivot pin 603 and the sliding jaw actuation roller pin 600, the force triangle second side 804 formed within the span of the pivotal strut 500 between its fixed handle to strut pivot pin 602 within the pivotal strut inner end pivot pin bore 502 and its moving handle central apex pivot pin 603 within the pivotal strut outer end pivot pin bore 504, during use as the operator provides clenching force CF forcing the moving handle 400 towards the fixed handle 200, the force triangle apex 802, the moving handle central apex pivot pin 603, is propelled towards the force triangle base 801, forcefully elongating said force triangle base 801 line, all the said triangle pivot pins 600, 602, 603 rotationally fixed within their allotted pivot pin bores 304, 404, 502, 211, 504, 402 all said pivot pins 600, 602, 603 being pivotal in the same plane, the moving handle 400, central pivot pin bore 402 is positioned as near as practical to the moving handle proximal end 401 within the moving handle grip 408 such that as clenching force CF is applied between the fixed and moving handle grips 213, 408 the greater part of the finger clenching force CF applied rotates the moving handle grip distil end 405 around the generally central moving handle triangle apex pivot pin 603, towards the fixed handle distil end 202, further rotating the moving handle distil end 405 around the generally central moving handle central apex pivot pin 603, towards the fixed handle distil end 202, further rotating the moving handle actuation arm 403 pivotally connected to the sliding jaw actuation roller pin bore and pin 304, 600, further forcefully propelling the sliding jaw gripping profile 302 towards the closed position against the fixed jaw gripping profile 208, the elongation closure forces employed provide an expedient and smooth closure function that can be because of the now greatly reduced distance between the said fixed and moving handles 200, 400 grips 213, 408 can easily be operated by one hand or smaller hands.

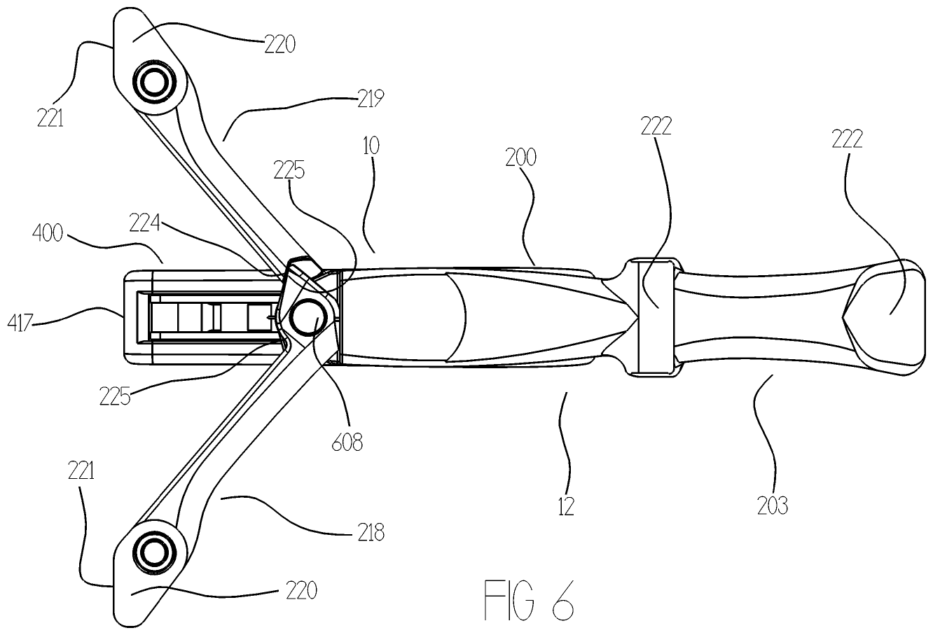

FIG. 6 illustrates Pliers 10 viewed from the rear aspect 12, comprising a further embodiment of the said Pliers 10 wherein the fixed handle 200 first and second fold out arms 218, 219 incorporate base feet 220, which when opened out, swivelling around the fold out arms pivot pin 608, they form with the aid of further fixed handle grip base feet 222 at the opposite fixed handle proximal end 203, very stable three legged base feet 220, 222 such to allow the Pliers 10 rear aspect 12 to be securely placed on a surface S such as a table or the like (not shown) with at least three said base feet 220, 222 protruding downwards such as to form a stable said base feet 220, 222 for the Pliers 10 operation, said base feet 220, 222 placed on a surface S, say a bench whereas the fixed and sliding jaws 207, 300 (not shown) are in best practice positioned generally upright enables any work piece W, held within said jaws 207, 300 to be most accessible. The moving handle 400 can now be manually operated by one hand usefully leaving the other hand to position the workpiece W within the fixed and sliding jaws 207, 300 (not shown). A further embodiment of the present invention is the method whereas when the fixed handle first and second fold out arms 218, 219 are folded out, the fixed handle fold out arm tip base feet 221 and moving handle grip fourth base foot 417 can be placed on a surface S such as a table or the like (not shown) with said base feet tips 221 and moving handle grip fourth base foot 417 forming a triangulated base allowing said Pliers 10 to be further utilized generally vertical, when placed in said Pliers upright aspect 13. A further embodiment of the present invention is the method whereas when the fixed handle first and second fold out arms 218, 219 are folded out they are locked in position by the fold out arm locking out and in protrusions 223 and fold out arm locking in and out indentations 224.

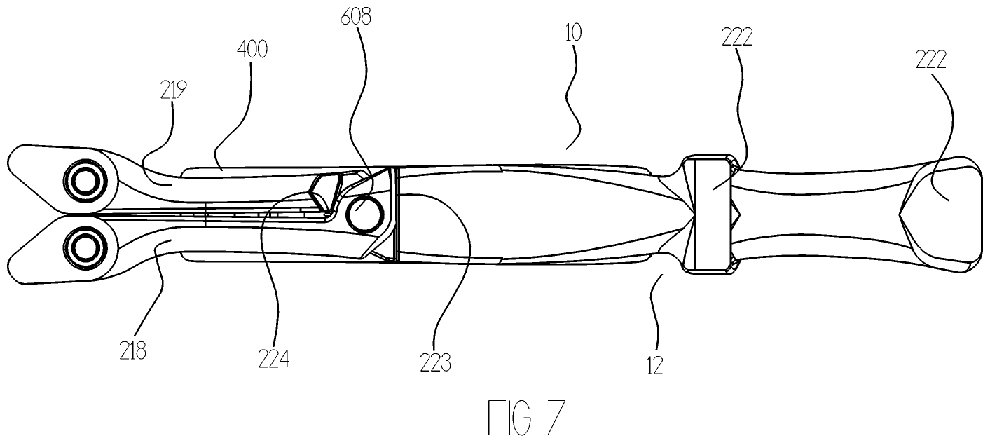

FIG. 7 illustrates the Pliers 10 viewed from the rear aspect 12, comprising a further embodiment of the present invention whereas when the first and second fold out arms 218, 219 are folded in, swivelling around the fold out arms pivot pin 608, they are locked in position by the fold out arm locking protrusions and indentations 223, 224. Said first and second fold out arms 218, 219 arms when folded in, lock in the folded in position in order to form a uniform unified handle 200 for normal known pliers use.

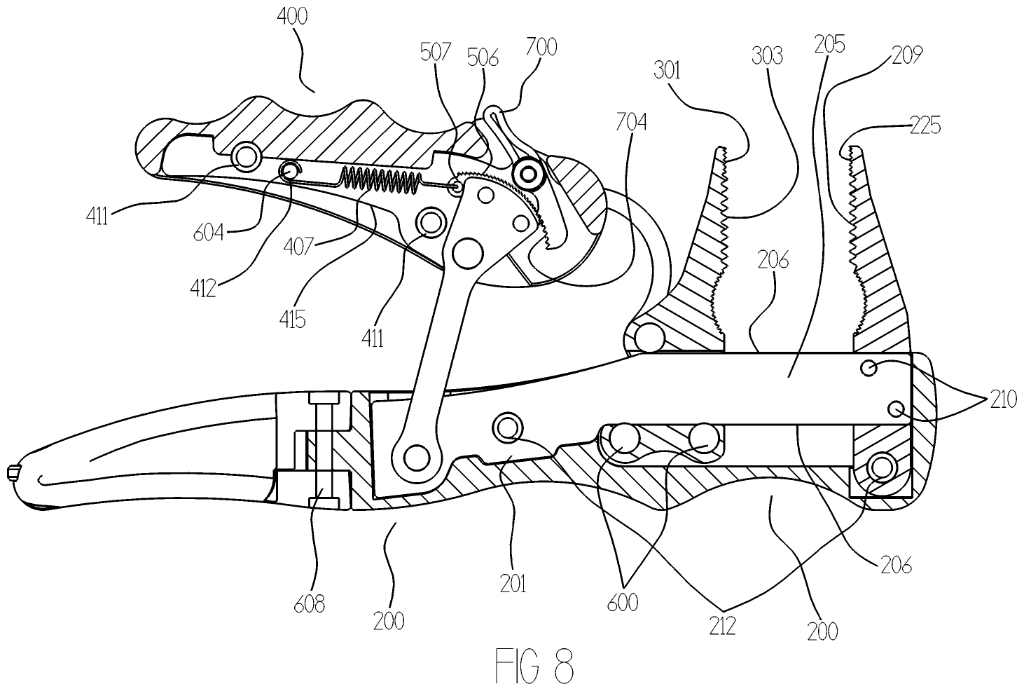

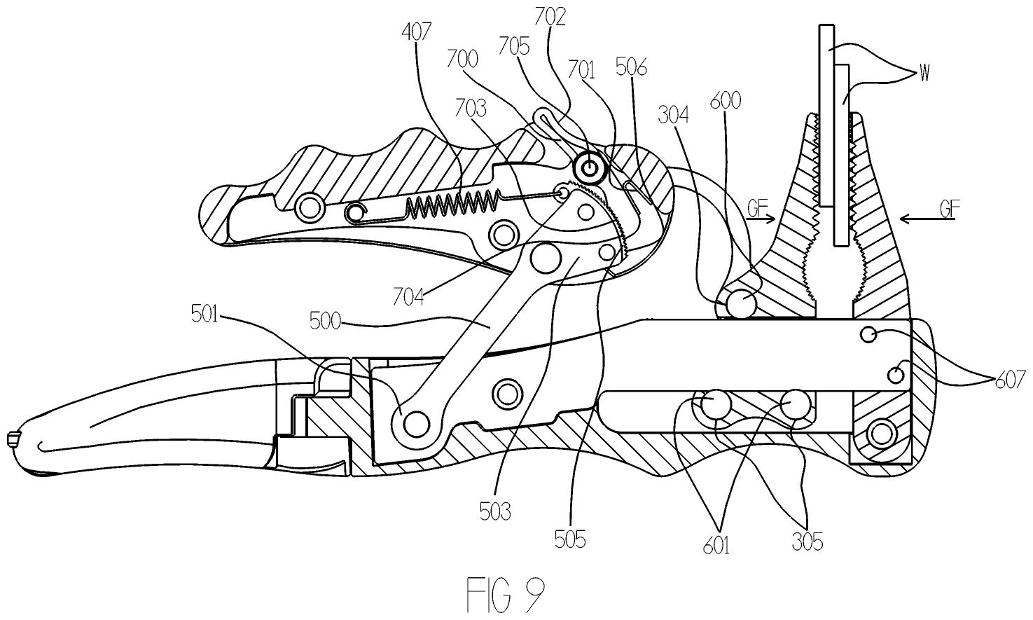

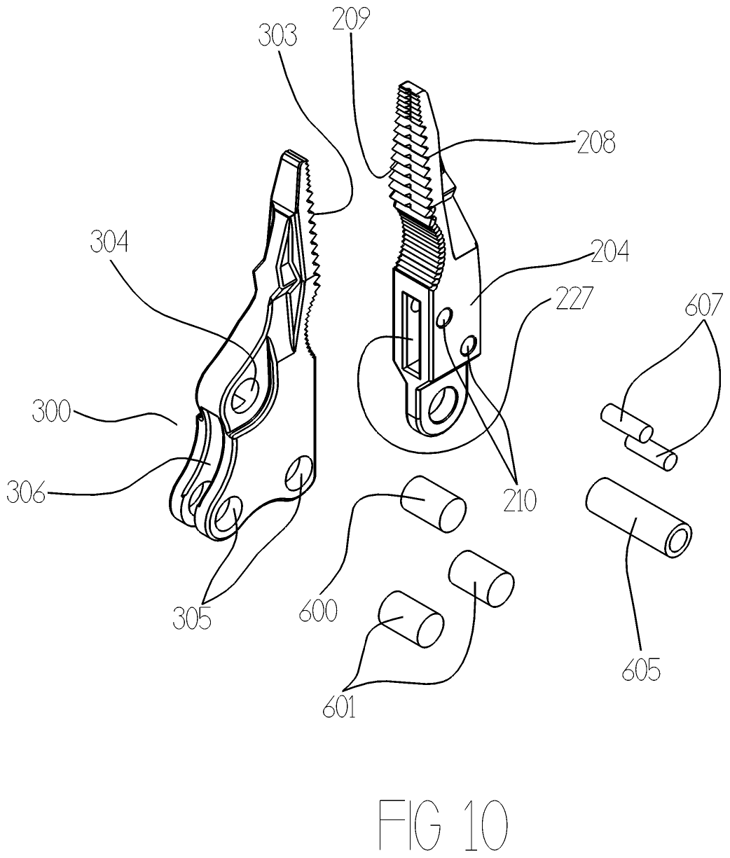

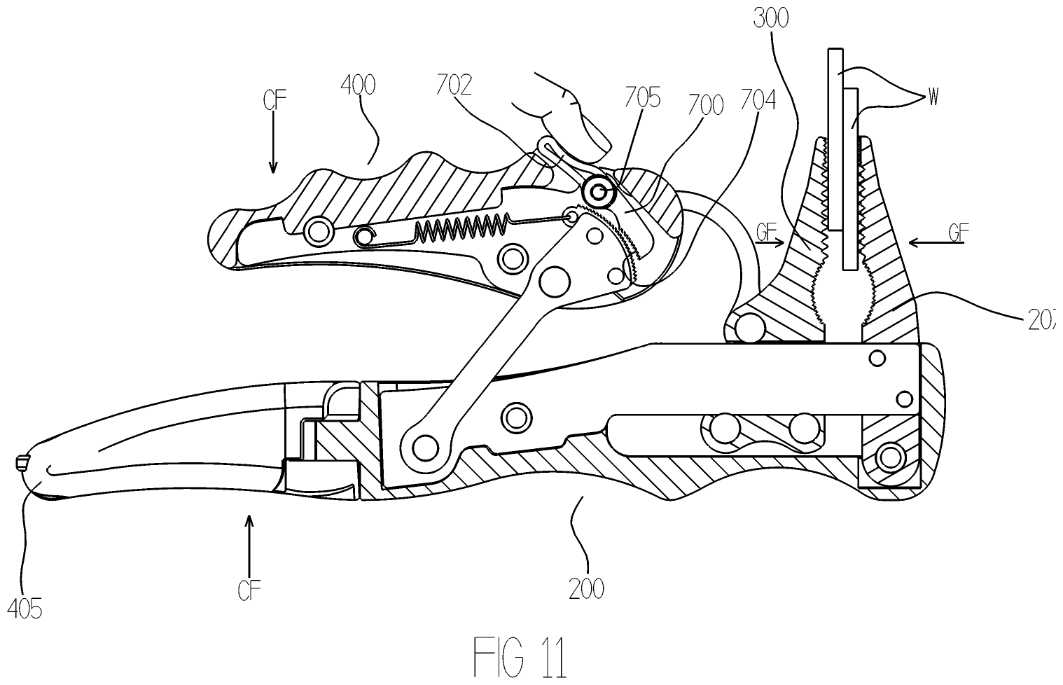

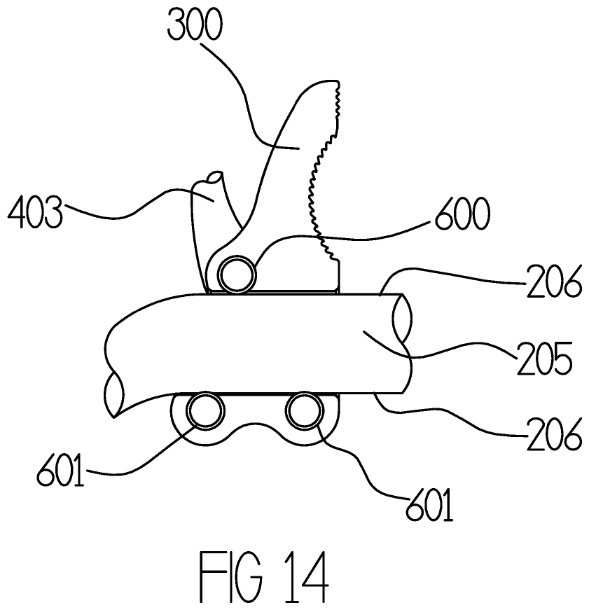

FIGS. 8, 9, 10, 11 and 14 illustrate the Pliers 10, denoting the second embodiment of the present invention, whereas the sliding jaw 300, when the moving handle 400 is operated, they close in a substantially parallel manner upon the fixed jaw 207, providing a superior grip upon most workpieces W. The sliding jaw 300 traverses as required along the fixed head parallel rail 205 roller surfaces 206, this embodiment is characterized by comprising in best practice a minimum of three roller pins 600, 601 situated within its sliding jaw parallel rail recess 306, the sliding jaw actuation roller pin 600 and two further stabilizing roller pins 601 within corresponding sliding jaw axle bores 304, 305, enable said sliding jaw 300, to glide along the fixed head parallel rail 205 roller surfaces 206, with a minimum of friction when it is propelled towards the closed position or retracted by the moving handle main spring 407 in the release or opening sequence. Said roller pins 600, 601 are rotationally held within the sliding jaw parallel rail recess 306 whereas said roller pins 600, 601 can rotate within their allotted sliding jaw actuation or stabilizing roller pin bores 304, 305 within said sliding jaw parallel rail recess 306, the correct orientation of said roller pins 600, 601 within said sliding jaw parallel rail recess 306 gives a triangulated, secure method of the sliding jaw 300 traversing the allotted length of the fixed head parallel rail 205 whilst ensuring the sliding jaw gripping profile 302 remains generally parallel to the fixed jaw 207 gripping profile 208. The tolerances between the roller pins 600, 601 within said sliding jaw parallel rail recess 306 and the corresponding fixed head parallel rail 205 roller surfaces 206 ensuring that the sliding jaw 300 remains at the preordained set angle to that of the fixed jaw 207 which is further robustly affixed to the fixed head parallel rail 205 by its correspondingly sized fixed jaw parallel rail recess 225 and associated fixed handle to fixed head pin holes 210.

The third embodiment of the Pliers 10, is the fixed and sliding jaw 207, 300 closure and locking un-locking sequence, wherein the pivotal strut 500 situated between the fixed handle to strut pivot pin 602 and the moving handle to central apex pivot pin 603 incorporates within the pivotal strut outer end 503 a toothed fan 505 utilizing single direction saw shaped toothed pivotal strut fan teeth 506, further characterized by the use of, in best commercial practice, a trigger finger operated, rocker switch 700 situated within the moving handle finger grip profiles 409, said rocker switch 700 axles 705 allowing said rocker switch 700 to pivot around the corresponding moving handle rocker switch axle bores 413 within the moving handle internal framework 415, a rocker switch closure spring 701 is further utilized to urge the rocker switch trigger profile 702 outwards in order to propel its opposite rocker switch toothed arc 703 resiliently into mesh with the correspondingly toothed pivotal strut toothed fan teeth 506 within the pivotal strut outer end 503 toothed fan 505. In order to construct a low-cost heavy duty, ratcheting locking mechanism, the pivotal strut toothed fan teeth 506 utilized further comprising a safety lock as the fixed and moving handles 200, 400 require to be clenched at the same clenching force CF used in the workpiece W gripping sequence before and as the said finger operated rocker switch 700 trigger profile 702 is operated, thereby smoothly and safely unlocking the said Pliers 10. The moving handle 400 is consistently urged towards the open position by the moving handle main spring 407 gripped between the pivotal strut fan spring hole 507 and the main spring retaining pin 604 within moving handle main spring pin holes 412. Said rocker switch 700 further characterized in a reduction of parts and costs by the direct inclusion of the rocker switch trigger profile 702 and toothed arc teeth 704 within the rocker switch 700. If the finger operated rocker switch 700 trigger profile 702 is compressed whilst the fixed and moving handles 200, 400 are clenched CF the Pliers 10 can be further conveniently utilized as known non-locking pliers. The utilization of the sets of opposing rocker switch toothed arc teeth 704 and pivotal strut toothed fan teeth 506 locking teeth 704, 506 being chosen to prevent inadvertent disengagement during the Pliers 10 use during the gripping sequence. A further embodiment of the Pliers 10 whereas they are specifically designed to reduce the manufacturing environmental impact to a minimum, the fixed and moving handles 200,400 internal frameworks 201, 415 are preferably made from stamped planar metal plate with their as required laminated layers 201, 415, 508 riveted 607 or pinned together, the fixed and moving handle grips 213, 408 in best practice being made from recycled plastic, said handle grips 213, 408 characterized by the fixed and moving handles internal framework/laminates 201, 414 engaging into slots 214, 416 within the fixed and moving handle grips 212, 408, the fixed handle dowel holes 212 held by assembly dowels 605. The moving handle grip 408, further engaged by its internal spacers 410 and affixed by assembly dowels 605 within said moving handle grip dowel holes 411 transforming the thin, sideways pliable metal moving handle internal framework 415 into an extremely ruggedized moving handle 400 whilst using the very minimum or absence of assembly rivets 607. The fold out arms pivot pin 608 is further shown. The assembly of the fixed and moving handle grips 213, 408 is further characterized by the use of appropriate lengths of in best practice tube like hollow assembly dowels 605 which when installed are suitably retained by the interaction by the edges of the fixed and moving handle dowel holes 215, 418 of the fixed and moving handle internal framework 201, 415 although solid assembly dowels 605 could be used the hollow dowels 605 slightly resilient walls, cost and weight reductions are preferable. This type of extremely cost effective and expedient (under 10 seconds) final assembly allowing several differing badged, cosmetic or colour, fixed and moving handle grip types 213, 408 as required to be fitted to a uniformly standard fixed or moving handle internal framework 201, 415 prior to despatch.

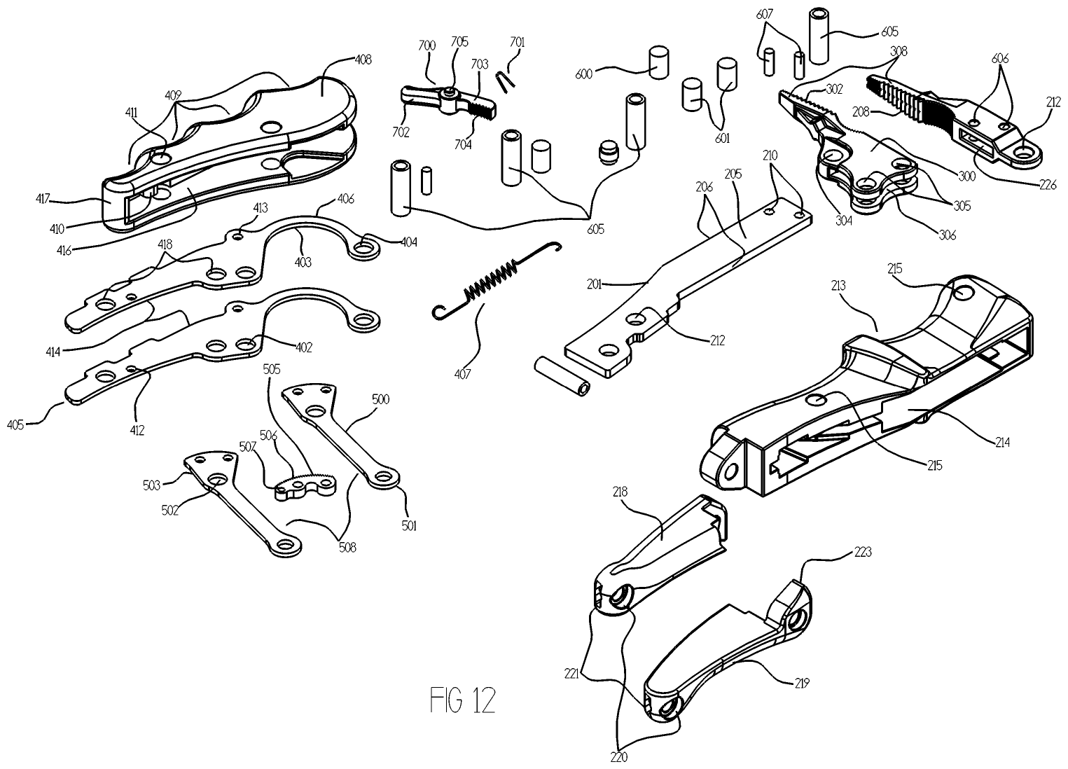

FIG. 12 is a perspective view of the Pliers 10, the main parts shown dismantled for display purposes the parts as previously denoted.

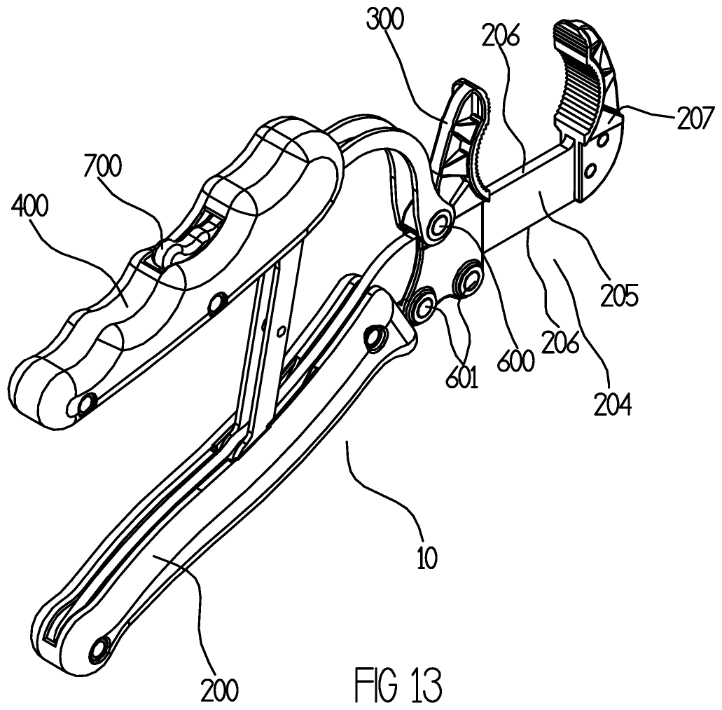

FIG. 13 is a perspective view of the Pliers 10, utilized without the fixed handle first or second fold out arms 218,219 for further use as parallel closing, locking or non locking, pliers, water pump pliers or clamps (not shown). Displayed are the fixed handle 200, fixed head portion 204, parallel rail 205 roller surfaces 206 and corresponding sliding jaw actuation and stabilizing roller pins 600, 601 for the ease of closure of the sliding jaw 300 towards the fixed jaw 207 when the moving handle 400 is operated towards the fixed handle 200, the optional rocker switch 700 is further illustrated.

A further embodiment of the invention 10 even further comprises a method whereas the fixed and sliding jaws 207, 300 are replaceable with other jaw 207, 300 type configurations in order that the Pliers 10 can be utilised in many differing marketplaces, for example jewellery, fishing, electronics, electrical to mention but a few. The methods of attachment of said fixed and sliding jaws 207, 300 being of known methods.

1. Pliers 10 comprising a sliding jaw 300 having a minimum of three roller pins 600, 601 situated within a sliding jaw parallel rail recess 306, the sliding jaw actuation roller pin 600 and two further stabilizing roller pins 601 within corresponding sliding jaw actuation and stabilizing roller pin bores 304, 305, enable said sliding jaw 300, to glide along the fixed head parallel rail 205 with less friction than if the sliding jaw slid directly on the fixed head parallel rail when it is propelled towards the closed position or retracted by the moving handle main spring 407 in the release or opening sequence. Said roller pins 600, 601 are rotationally held within the sliding jaw parallel rail recess 306 whereas said roller pins 600, 601 can rotate within their allotted sliding jaw actuation or stabilizing roller pin bores 304, 305 within said sliding jaw parallel rail recess 306, the correct orientation of said roller pins 600, 601 within said sliding jaw parallel rail recess 306 give a triangulated, secure method of the sliding jaw 300 traversing the allotted length of the fixed head parallel rail 205 whilst ensuring the sliding jaw gripping profile 302 remains generally parallel to the fixed jaw 207 gripping profile 208.

2. Pliers 10 as claimed in claim 1, wherein the sliding jaw parallel rail recess 306 is in best practice open to the sliding jaw rear aspect 307, the opposite end from the sliding jaw outer gripping point 308, at the time of writing in best practice in order to retain fine detail and manufacturing tolerances, at reasonable cost the preeminent method of production is MIM (metal injection moulding) by having the sliding jaw parallel rail recess 306 open at the sliding jaw rear aspect 307 makes said Pliers 10 lighter and far easier to mould whilst reducing the expensive material cost.

3. Pliers 10 comprising a fixed handle 200 incorporating a metal fixed internal framework 201, a fixed head portion 204 incorporating its fixed jaw 207 within the fixed handle proximal end 203 and a fixed handle grip 213 encompassing its distil end 202, the moving handle 400 further pivotally attached at its moving handle proximal end 401, to the sliding jaw 300 by the sliding jaw actuation roller pin 600, characterised wherein a non-adjustable scalene or Isosceles type force triangle 800 is formed with its force triangle base 801 situated at one end between the pivotal strut 500 inner end 501 pivot pin bore 502 and fixed handle to strut pivot pin bore 211 by the fixed handle to strut pivot pin 602 and at its other end the sliding jaw actuation pin 600 pivotal within the sliding jaw actuation roller pin bore 304 and moving handle actuation arm pin bore 404, the force triangles apex 802 being formed within the pivotal strut outer end pivot bore 504 and corresponding moving handle central pivot pin bore 402 and further incumbent force moving handle central apex pivot pin 603, the force triangle first side 803 formed between the moving handle 400 central apex pivot pin 603 and the sliding jaw actuation roller pin 600, the force triangle second side 804 formed within the span of the pivotal strut 500 between its fixed handle to strut pivot pin 602 and its moving handle central apex pivot pin 603, during use as the operator provides clenching force CF forcing the moving handle 400 towards the fixed handle 200, the force triangles apex 802, the moving handle central apex pivot pin 603, is propelled towards the force triangle base 801, forcefully elongating said force triangle base 801 line, all the said triangle pivot pin 601, 602, 603 points rotationally fixed within their allotted pivot bores 304, 404, 502, 211, 504, 402 said pivot pins 601, 602, 603 being pivotal in the same plane, the moving handle central strut pivot pin bore 402 is positioned as near as practical to the moving handle proximal end 401 within the moving handle grip 408 such that as clenching force CF is applied between the fixed and moving handle grips 213, 408 the greater part of the finger clenching force CF applied rotates the moving handle distil end 405 around the moving handle central apex pivot pin 603, towards the fixed handle distil end 202, further rotating the moving handle actuation arm 403 pivotally connected to the sliding jaw actuation roller pin bore and pin 304, 600, further forcefully propelling the sliding jaw gripping profile 302 towards the closed position against the fixed jaw gripping profile 208, the elongation closure forces employed provide an expedient and smooth closure function that can be because of the now greatly reduced distance between the said fixed and moving handles 200, 400 grips 213, 408 can easily be operated by one hand or smaller hands.

4. Pliers 1 as claimed in claim 3, wherein the pivotal strut 500 which comprises the force triangles 800 first side 803 situated between the fixed handle to strut pivot pin 602 and the moving handle central apex pivot pin 603 incorporates within the pivotal strut outer end 503 a toothed fan 505 utilizing single direction saw shaped pivotal strut toothed fan teeth 506, further characterized by the use of, in best commercial practice, a trigger finger operated, rocker switch 700 situated within the moving handle grip finger profiles 409, said rocker switch 700 having generally central, rocker switch axles 705 allowing said rocker switch 700 to pivot around corresponding moving handle rocker switch axle bores 413 within the moving handle internal framework 415, a rocker switch closure spring 701 is further utilized to urge the rocker switch trigger profile 702 outwards in order to propel its opposite rocker switch toothed arc 703 resiliently into mesh with the correspondingly toothed and profiled, pivotal strut toothed fan teeth 506, within the pivotal strut outer end 503 toothed fan 505, in order to construct a low cost heavy duty, ratcheting locking mechanism, the pivotal strut toothed fan teeth 506 utilized further comprising a safety lock as the fixed and moving handles 200, 400 require to be clenched at the same clenching force CF used in the workpiece W gripping sequence before and as the said finger operated rocker switch 700 trigger profile 702 is operated, thereby smoothly and safely unlocking the said Pliers 10, further characterized in a reduction of parts and costs by the direct inclusion of the rocker switch trigger profile 702 and toothed arc teeth 704 within the rocker switch 700.

5. Pliers 10 as claimed in any one of the previous claims, wherein in order to further reduce the manufacturing environmental impact to a minimum, the fixed and moving handles internal frameworks 201, 415 are preferably made from stamped planar metal plate with their as required laminated layers 201, 414, 508 riveted 607 or pinned together, the fixed and moving handle grips 213, 408 in best practice being made from recycled plastic, said handle grips 213, 408 characterized by the fixed and moving handles internal framework 201, 414 engaging into slots 214, 416 within the fixed and moving handle grips 213, 408, the moving handle grip 408, further engaged by its internal spacers 410, transforming the thin, sideways pliable metal moving handle internal framework 415 into a extremely ruggedized moving handle 400 whilst using the very minimum or absence of assembly rivets 607.

6. Pliers 10 as claimed in any one of the previous claims, wherein the fixed and moving handle grips 213, 408 are specifically ergonomically shaped to provide one handed ease of use by smaller hands, characterized wherein the fixed handle grip 213 has a concave shape portion 216 for contact with the operators web between the thumb and forefinger, the moving handle grip 408 having further finger grip profiles 409 formed according to normal corresponding finger lengths from the fixed handle grip 213 giving superior enablement of use by smaller hands.
Pliers 1 as claimed in claim 6, characterized wherein if the finger operated rocker switch 700 trigger profile 702 is compressed whilst the fixed and moving handles 200, 400 are clenched the Pliers 1 can be further conveniently utilized as non-locking pliers.

7. Pliers 1 as claimed in any one of the previous claims, wherein instead of the fixed and moving handle grips 213, 408 being affixed to the moving and fixed handles 400, 200, by expensive over-moulding, screws, rivets, etcetera, the final assembly is characterized by the use of appropriate lengths of in best practice tube like hollow assembly dowels 605 which when installed are suitably retained by the interaction by the edges of the fixed and moving handle grip dowel holes 215, 418 of the fixed and moving handle internal framework 201, 415 although solid assembly dowels 605 could be used the hollow dowels 605 slightly resilient walls, cost and weight reductions are preferable, this type of extremely cost effective and expedient (under 10 seconds) final assembly allowing several differing badged, cosmetic or colour, fixed and moving handle grip types 213, 408 as required to be fitted to a uniformly standard fixed or moving handle internal framework 201, 415 prior to despatch to different major sales customers.

8. Pliers 10 as claimed in any one of the previous claims, wherein the fixed handle 200 incorporates the first and second fold out arms 218, 219, further incorporating the first and second fold out arm base feet 220, which when opened out form with the aid of fixed handle grip base feet 222 incorporated within the fixed handle proximal end 203, form a very stable three legged foundation such as to allow the Pliers rear aspect 12 to be placed on a table or the any other placement surface, with the three base legs or feet protruding downwards such as to form a stable base for said Pliers 10 operation, whereby the moving handle 400 can now be manually operated by one hand thereby leaving the other free hand to position the workpiece W, the fixed and sliding jaw outer gripping points now being upmost, further characterised wherein the moving handle distil end 405 of the moving handle grip 408 takes the form of a fourth base foot 417, the first and second fold out arm 218, 219 base feet 220 tips 221, therefore the first and second fold out arms 218, 219 when opened out, now allow the Pliers 1, to be positioned generally upright with the fixed and sliding gripping jaw profiles 208, 302 somewhat parallel to the placement surface S.

9. Pliers comprising:
a fixed jaw and a moving jaw that is movable towards and away from said fixed jaw to vary the size of a gap therebetween;
a fixed handle comprising a hand grip portion and a guide rail for the moving jaw, said fixed jaw being fixed to said fixed handle such that said guide rail is disposed between said fixed jaw and said hand grip portion; and
a moving jaw handle connected with said moving jaw for moving the moving jaw along said guide rail towards said fixed jaw,
wherein said guide rail disposes a first guide surface and a second guide surface disposed opposite and spaced from said first guide surface and said moving jaw is provided with a first roller pin engaged with said first guide surface and a second and third guide roller pin each engaged with said second guide surface.

10. Pliers as claimed in claim 10, wherein said guide rail comprises a recess and said guide rail is at least partially disposed in said recess.

11. Pliers as claimed in claim 10, wherein said first roller pin is disposed externally of said recess and said second and third roller pins are disposed within said recess.

12. Pliers as claimed in claim 9, 10 or 11, wherein said moving jaw handle is pivotally connected to said moving jaw via said first roller pin.

13. Pliers as claimed in any one of claims 9 to 12, wherein said moving jaw handle is provided with a return spring configured to bias said moving jaw in a direction away from said fixed jaw.

14. Pliers as claimed in any one of claims 9 to 13, further comprising a strut having a first end pivotally connected with said fixed handle by a first pivot pin positioned such that said moving jaw is disposed intermediate said first pivot pin and said fixed jaw and a second end pivotally connected with said moving jaw handle by a second pivot pin positioned such that said first and second pivot pins and said first guide roller define respective corners of an imaginary triangle having a base extending between said first guide roller and said first pivot pin and an apex defined by said second pivot pin.

15. Pliers as claimed in claim 14, wherein said second end of said strut is provided with a plurality of teeth and further comprising a switch fitted to said moving handle, said switch being engageable with said plurality of teeth to limit movement of said movable jaw.

16. Pliers as claimed in claim 15, further comprising a spring provided on said moving jaw handle and configured to bias said switch into engagement with said plurality of teeth.

17. Pliers as claimed in any one of claims 9 to 16, wherein said fixed jaw is fixed to a first end region of said fixed jaw handle and a first fold out arm and a second fold out arm are pivotally connected with a second end region of said fixed jaw handle disposed opposite and spaced apart from said first end region, said fold out arms being movable from a first position in which each fold out arm is in line with said fixed jaw handle and a second position in which respective free ends of said fold out arms are disposed laterally outwardly of said fixed jaw handle such that said free ends and at least a portion of said fixed jaw handle define a three point standing base for said pliers.
